(19) United States
(12) Patent Application Publication
(10) Pub. No.: US 2009/0098267 A1
(43) Pub. Date: Apr. 16, 2009

(54) USE OF INORGANIC PHOSPHATE COMPOUNDS AS PALATABILITY ENHANCERS OF FLAVOURS GENERATED BY THERMAL REACTIONS IN WET PET FOODSTUFFS

(75) Inventors: Elodie Pettelot, Gourhel (FR); Aurelie De Ratuld, Ploeren (FR); Isabelle Guiller, Le Tour Du Parc (FR)

Correspondence Address: BIRCH STEWART KOLASCH & BIRCH, PO BOX 747, FALLS CHURCH, VA, 22040-0747, US

(73) Assignee: Specialites Pet Food, Paris (FR)

(21) Appl. No.: 12/297,376

(22) PCT Filed: Apr. 17, 2007
(86) PCT No.: PCT/EP2007/053713

§ 371 Date: Oct. 16, 2008

Related U.S. Application Data
(60) Provisional application No. 60/792,961, filed on Apr. 19, 2006.

(51) Int. Cl. A23K 1/18; A23K 1/16; A23L 1/227

(52) U.S. Cl. 426/520; 426/533; 426/534

(57) ABSTRACT

The present invention concerns means and methods for obtaining an edible or drinkable wet pet foodstuff having enhanced palatability, by heating an edible or drinkable foodstuff preparation comprising: —at least one inorganic phosphate compound, preferably at least one inorganic pyrophosphate; and—at least one thermal reaction-generated flavour and/or aminoacid and reducing sugar precursors thereof.

The present invention relates to palatability enhancers useful in wet food products and beverages for pets.

More precisely, the present invention provides means and methods for obtaining an edible or drinkable wet pet foodstuff having enhanced palatability, by heating an edible or drinkable foodstuff preparation comprising:
at least one inorganic phosphate compound, preferably at least one inorganic pyrophosphate; and
at least one thermal reaction-generated flavour and/or aminoacid and reducing sugar precursors thereof.

Pet food manufacturers are constantly searching for foods which combine high nutritional value, high degree of palatability, and low production costs.

The pet foods available to date on the market may be classified in three groups based upon their moisture content:
high-moisture foods (generally, of at least 50% moisture), a typical example thereof is canned foods;
dry or low-moisture foods (generally, containing less than 15% moisture); and
semi-dry or intermediate foods (typically with about 15 to 50% moisture).

Means and methods for enhancing the palatability of dry and semi-dry pet foods have been reported so far. Most of them use inorganic pyrophosphates, including disodium pyrophosphate (U.S. Pat. No. 5,186,964 published on Feb. 16, 1993), trisodium pyrophosphate (U.S. Patent application No. 2004/0247741 published on Dec. 9, 2004), tetrasodium or tetrapotassium pyrophosphate (U.S. Pat. No. 6,254,920 published on Jul. 3, 2001; U.S. Pat. No. 6,350,485 published on Feb. 26, 2002; U.S. Patent application No. 2005/0170067 published on Aug. 4, 2005; U.S. Patent application No. 2005/0037108 published on Feb. 17, 2005), alone or in combination with other flavourings or taste factors, for enhancing the palatability of dry and semi-dry pet foods. In these dry or semi-dry applications, no essential step of heat treatment is performed after the pyrophosphate(s) is(are) added. Moreover, the palatable combination of pyrophosphates and flavourings or taste factors are obviously not used in solution for the purposes of dry and semi-dry food applications.

Also, liquid drink compositions (comprising 80-99.9% water) have been disclosed in International patent application No. WO 95/28854, published on Nov. 2, 1995. These compositions are described as being rendered palatable to the animals upon flavor adding. They also contain a tartness and palatability enhancer (a phosphate compound, e.g., a pyrophosphate compound) which is used for adjusting the pH of the drink compositions. These compositions are made by stirring water, first with preservatives, second with a blended mixture of powdered vitamins, minerals, amino-acids, carbohydrates, third with liquid flavor(s), until dissolution. In some embodiments, high fructose corn syrup may be added (in dog beverages only). Then, pH is adjusted using a phosphate compound and carbonation is added to achieve a 2-2.25% level of carbonation. No essential step of heat treatment is performed during the manufacturing process of these compositions.

The high-moisture foods are supposed to be intrinsically more palatable than dry or semi-dry foods, owing to the general assumption that they contain sufficient meat- or seafood-based materials for rendering the foods appetizing enough to the animals. However, in view of the increasing number of different pet food products currently on the market, pet food manufacturers are coming more and more interested in providing pet foods having ever-increasing palatability in order to make these foods the first choice of the pets.

There is thus a need in the art for means and methods for increasing the palatability of wet pet foods and pet beverages, without increasing the production costs neither complicating the manufacturing process to an unacceptable extent.

Such means and methods are provided for the first time by the present invention. As it is shown below, these means and methods make it possible to obtain very satisfying palatability results, without involving high expenses neither requiring cumbersome procedures of preparation.

According to a first aspect, the present invention concerns a method for preparing a heat-treated, palatable wet pet foodstuff.

In a first embodiment, said method comprises:

a) adding 1) at least one inorganic phosphate compound and 2) precursors of at least one thermal reaction-generated flavour, to a wet pet foodstuff preparation;
b) heating the resulting preparation at a temperature in the range of about 100 to 150° C. for about 8 to 100 minutes; and
c) obtaining said palatable wet pet foodstuff, wherein palatability of said at least one thermal reaction-generated flavour is enhanced by said inorganic phosphate compound.

Indeed, the Inventors have unexpectedly realized that, upon heating precursors of thermal reaction-generated flavour(s) in the presence of inorganic phosphate compound(s), it is possible to enhance the flavouring properties of the flavour(s) generated by thermal reaction.

In a second embodiment, said method comprises:

a) adding 1) at least one inorganic phosphate compound and 2) at least one thermal reaction-generated flavour, to a wet pet foodstuff preparation;
b) heating the resulting preparation at a temperature in the range of about 100 to 150° C. for about 8 to 100 minutes; and
c) obtaining said palatable wet pet foodstuff, wherein palatability of said at least one thermal reaction-generated flavour is enhanced by said inorganic phosphate compound.

In a third embodiment, said method comprises:

a) adding 1) at least one inorganic phosphate compound and 2) at least one thermal reaction-generated flavour and precursors thereof, to a wet pet foodstuff preparation;
b) heating the resulting preparation at a temperature in the range of about 100 to 150° C. for about 8 to 100 minutes; and
c) obtaining said palatable wet pet foodstuff, wherein palatability of said at least one thermal reaction-generated flavour is enhanced by said inorganic phosphate compound.

The Inventors have thus surprisingly discovered that it is possible to enhance the flavouring abilities of yet existing flavours (that have been generated by thermal reaction) by associating these flavours to inorganic phosphate compound(s) and by heating the resulting association.

In the context of the present invention, in all cases where “thermal reaction-generated flavour(s) and precursors thereof” are simultaneously used, the precursors react upon heating to give at least one thermal reaction-generated flavour, which may be identical to or different from the at least one flavour initially present. Of course, in the last step of the methods which are the subject-matters of the present invention, it has to be understood that reference is made to all thermal reaction-generated flavours that may be present.

For the purposes of conciseness, it may be referred to the three embodiments of the above-described method as follows. The first aspect of the present invention concerns a method for preparing a heat-treated, palatable wet pet foodstuff, comprising:

a) adding 1) at least one inorganic phosphate compound and 2) at least one thermal reaction-generated flavour and/or precursors thereof, to a wet pet foodstuff preparation;
b) heating the resulting preparation at a temperature in the range of about 100 to 150° C. for about 8 to 100 minutes; and
c) obtaining said palatable wet pet foodstuff, wherein palatability of said at least one thermal reaction-generated flavour is enhanced by said inorganic phosphate compound.

More generally, for all aspects of the present invention, reference to “at least one thermal reaction-generated flavour and/or precursors thereof” (also described as “thermal reaction-generated flavour(s) and/or precursors thereof”), actually means that either (i) precursors of at least one thermal reaction-generated flavour are present, or (ii) at least one thermal reaction-generated flavour is present, or (iii) both precursors of at least one thermal reaction-generated flavour and at least one thermal reaction-generated flavour are present.

By using the terms “heat-treated”, it is meant herein that the foodstuff is cooked or stewed, or baked or steamed, or sterilized or retorted.

The terms “palatable” and “appetizing” are to be considered as synonymous. Also, the expressions “palatability enhancer” and “taste enhancer” (mainly used herein when referring to the inorganic phosphate compounds) are equivalent.

By <<enhanced palatability >>, it is meant herein that the palatability of a given product is higher than the palatability of the same product lacking at least one of the following: (i) an inorganic phosphate compound, (ii) a precursor of at least one flavour generated by thermal reaction (i.e., a reducing sugar or an aminoacid), (iii) at least one flavour generated by thermal reaction.

By “wet” foodstuff, it is meant herein that said foodstuff is no less than about 60% moisture, preferably no less than about 70% moisture, more preferably no less than about 75% moisture.

Typically, said foodstuff is less than about 99.9% moisture, preferably less than about 98% moisture. In some embodiments, said foodstuff is less than about 95% moisture, or less than about 90% moisture, or even less than about 85% moisture. In other embodiments, said foodstuff is from about 60% to 99.9% moisture, preferably from about 70% to 98% moisture, more preferably from about 75% to about 95% moisture.

According to the present invention, the foodstuff may be edible (a food) or drinkable (a beverage). The term “beverage” encompasses all liquids and liquid preparations that can be laped by pets, e.g., milks for cats.

In an embodiment, said edible foodstuff may be chosen from “chunk-in-X” products and loafs.

By ““chunk-in-X” products”, it is meant herein all edible foodstuffs comprising chunks in a preparation (said preparation being also called “the X preparation” with respect to the generic expression “chunk-in-X” used herein), classical examples of which are chunk-in-jelly products, chunk-in-gravy products, and the like. This category of “chunk-in-X” products encompasses also edible forms other than chunks that may be contained in the X preparation such as a jelly, a gravy, and the like. For instance, other forms than chunks may be sliced products, grated products, etc.

The term “loafs” as used herein not only covers the loafs but also all edible foodstuffs usually called terrines, pâtés, mousses, and the like.

In particular, when said edible foodstuff is a loaf, it is possible to use the second or the third embodiment of the method described above. In these cases, during step a), it is added, 1) at least one inorganic phosphate compound and either 2) at least one thermal reaction-generated flavour or 2) at least one thermal reaction-generated flavour and precursors thereof. Of course, the first embodiment of the method according to the present invention may also be advantageously used for preparing a loaf.

The “chunk-in-loaf” products are encompassed by either of both categories of edible foodstuffs above.

In particular, when said edible foodstuff is a “chunk-in-X” product, it is possible to add said inorganic phosphate compound and said precursors and/or said at least one flavour in step a) to the “X preparation”, or to the chunks, or both. In some embodiments, said inorganic phosphate compound and said precursors and/or said at least one flavour are advantageously added in step a) to the “X preparation”.

In another embodiment, said drinkable foodstuff may be chosen from waters, milks, jellies, gravies, seasonings, and the like.

Preferably, the “pet” in the context of the invention is a cat or a dog, yet preferably a cat.

Prior to step a), the wet pet foodstuff preparation and/or at least one ingredient comprised therein may have been cooked or stewed or baked or steamed (this is the case when the foodstuff to be prepared is, for instance, chunk-in-jelly, chunk-in-gravy, and the like). This does not prevent further heating of the preparation according to step b), which is an essential step for producing the flavour(s) and for having the palatability thereof been enhanced by said inorganic phosphate compound acting here as a palatability enhancer (or taste enhancer). Preferably, this further heating is a sterilization or a retort sterilization. Alternatively, the foodstuff preparation used in step a) may be uncooked or unstewed or unbaked or unsteamed (this is the case when the foodstuff to be prepared is, for instance, a beverage or a loaf).

The wet foodstuff preparation used in step a) may further comprise one or more ingredients selected from farinaceous materials (such as grain-based materials and flours), animal by-products, fresh animal tissues, fresh fish tissues, animal or vegetable fats, seafood-based materials, vitamins, minerals, preservatives, enzymes, emulsifiers, surfactants, texturizing agents, colouring agents, and the like. Such additional ingredients are well-known by the skilled artisan and will be chosen appropriately depending on the wet foodstuff.

In the method according to the present invention, said step a) may be performed at a temperature suitably chosen by the person skilled in the art depending on the foodstuff. Typically, the temperature is from about 1° C. to 60° C. Where appropriate, the temperature in step a) is room temperature.

According to the present invention, thermal reactions include, but are not limited to, Maillard reactions. Such thermal reactions are well known by the person skilled in the art. In this respect, the highly-documented Maillard reaction is actually the first step of a series of thermal reactions resulting in the chemical conversion of reducing sugars (carbonyl groups) and aminoacids (free amino groups) into melanoid compounds. Nevertheless, it is also commonly referred to the “Maillard reaction” for designating a non-enzymatic browning involving in fact this series of thermal reactions between reducing sugars and aminoacids. Thus, with this enlarged meaning, the “Maillard reaction” is equivalent to the “thermal reaction”.

As used herein, the terms “thermal reaction” mean any type of thermal reactions occurring in the chemical pathway leading to melanoid compounds, from starting materials (or precursors) which are aminoacids and reducing sugars. This means that, even if it is herein indicated “thermal reaction”, it is referred rather to a series of thermal reactions than to one reaction only, depending upon the reaction conditions (time, temperature, etc., see below). The “thermal reaction” according to the present invention may thus result, depending upon the conditions, in the formation, not only of melanoid compounds, but also of non-further reacting intermediates such as aromatic compounds (for more information on thermal reactions, see J. E. Hodge, Chemistry of browning reactions in model systems, J. Agric. Food Chem., 1953, 1: 928-943).

The expression “precursors of at least one thermal reaction-generated flavour”, these precursors being added in step a) above, is clearly understood by the skilled artisan to mean that the “precursors” comprise at least one reducing sugar and at least one aminoacid.

Thus, thermal reaction enables one to produce, upon heating amino acids and reducing sugars, various compounds having different chemical structures. Some of these compounds have specific flavouring activity.

It is herein referred to these various flavouring compounds obtainable by thermal reaction when using the terms “at least one thermal reaction-generated flavour”. This means that not only one flavour may be present, but rather a mixture of various flavours.

Also, it is known that some flavourings or taste factors commonly used in food industry typically contain thermal reaction-generated flavour(s). For instance, one may cite the marketed taste factor disclosed in Example 7 below. More generally, taste factors that have been obtained upon processing (for example, taste factors that have undergone heat treatment(s), preferably with prior hydrolysis), typically contain thermal reaction-generated flavour(s). Non-limitative examples of processed taste factors that may be appropriately used are processed poultry/meat digests, processed yeast extracts, processed hydrolyzed vegetable proteins, and the like. Therefore, as used herein, the terms “at least one thermal reaction-generated flavour” also encompass such processed flavourings or taste factors containing thermal reaction-generated flavour(s).

The number and the ratio of thermal reaction-generated flavouring compounds are depending on the conditions of the thermal reaction(s). It is worth noting that aminoacids and reducing sugars, upon reacting together, may be, either totally or partially only, converted into the flavouring compounds. Therefore, it may be possible that some aminoacids and reducing sugars remain after thermal reaction(s) has(ve) taken place, depending on the reaction conditions.

Not only the temperature and the time of reaction influence the number, the type and the ratio of the flavours thus obtained, but also the nature of the precursors, the pH, the moisture level, etc.

According to the present invention, essential parameters for obtaining at least one appropriate flavour useful in wet pet foodstuffs (usually, it is actually obtained a mix of appropriate flavours) include the heating temperature, the heating time conditions, the moisture level of the foodstuff material. All the relevant parameters for obtaining the appropriate flavours according to the invention are herein disclosed in detail.

The time and temperature conditions of the heating step b) above correspond to the time and temperature conditions of the sterilization “plateau”, which means that once the rated temperature is reached, this temperature is maintained for the indicated period of time, for sterilization. The sterilization “plateau” is of course preceded by a heat-up phase and followed by a cool-down phase, these phases being typically as short as possible, depending on the capacities of the sterilization device that is used. The heating temperature in step b) is preferably about 121 to 135° C., more preferably about 121 to 128° C. The heating step b) is preferably of about 10 to 80 minutes, more preferably of about 20 to 75 minutes.

The reducing sugars are preferably selected from lactose, maltose, glucose syrup (or dextrose), fructose, mannose, arabinose, xylose, ribose, and combinations thereof. More preferably, at least xylose is used. Ribose may also or alternatively be used in a satisfying manner. However, using ribose will result in a higher, and possibly prohibitive, cost of the foodstuff. In addition, or yet alternatively, glucose syrup or dextrose may be conveniently used since it is costless and easily available. In some embodiments, the person skilled in the art may also or alternatively use molasses.

As used herein, the term “aminoacid” encompasses of course the twenty known natural aminoacids. More preferably, the aminoacids used in step a) are chosen from glycine, cysteine, aspartic acid, lysine, tryptophan, glutamic acid, phenylalanine, isoleucine, valine, leucine, methionine, threonine, and combinations thereof. Also, the term “aminoacid” encompasses aminoacid sequences, i.e., peptides, oligopeptides, and proteins. In the context of the present invention, the term “aminoacid” further encompasses any sulphur- or nitrogen-donor compound that may be thermally transformed, modified or converted, or that may react upon thermal treatment with other compounds in the reaction medium (such as reducing sugars and thermal reaction intermediates derived from reducing sugars and aminoacids). Non-limiting examples of sulphur- or nitrogen-donor compounds include thiamine, H₂S, taurine, sulphur flower, etc.

In one embodiment, the at least one thermal reaction-generated flavour and/or precursors thereof are added in step a) in the form of dry powder(s).

Advantageously, the at least one thermal reaction-generated flavour and/or precursors thereof are added in step a) at from about 0.05 to 3% (w/w), preferably at from about 0.1 to 2% (w/w), more preferably at from about 0.5 to 1.8% (w/w), yet more preferably at from about 0.7 to 1.5% (w/w) of the final foodstuff.

By “the final foodstuff”, it is meant herein the foodstuff obtained at the end of the method of preparation according to the present invention.

It is preferred to use herein as inorganic phosphate compounds, inorganic pyrophosphates. The inorganic pyrophosphates are preferably alkali metal pyrophosphates, encompassing monoalkali metal pyrophosphates and polyalkali metal pyrophosphates.

The formula MₓH_{y}PₙO₃ₙ₊₁ when n=2 is the general formula for alkali metal pyrophosphates. When M is a univalent metal, then x+y=n+2. When M is a divalent metal, then x+y=n. Univalent metal pyrophosphates and divalent metal pyrophosphates can be used in the invention.

Examples of monoalkali metal pyrophosphates include sodium trihydrogen pyrophosphate, potassium trihydrogen pyrophosphate, calcium hydrogen pyrophosphate, barium hydrogen pyrophosphate, magnesium hydrogen pyrophosphate.

Polyalkali metal pyrophosphates encompass dialkali metal pyrophosphates, trialkali metal pyrophosphates, tetralkali metal pyrophosphates, etc.

Examples of dialkali metal pyrophosphates are disodium dihydrogen pyrophosphate, dipotassium dihydrogen pyrophosphate, dicalcium pyrophosphate, dibarium pyrophosphate, dimagnesium pyrophosphate, dimanganese pyrophosphate, dizinc pyrophosphate.

Trialkali metal pyrophosphates are, for example, trisodium hydrogen pyrophosphate, tripotassium hydrogen pyrophosphate.

Preferably, the at least one inorganic phosphate compound used herein is selected from disodium pyrophosphate, trisodium pyrophosphate, tetrasodium pyrophosphate, dipotassium pyrophosphate, tripotassium pyrophosphate, tetrapotassium pyrophosphate, tetraferric pyrophosphate, and combinations thereof.

The pyrophosphates used in the invention may be anhydrous or hydrated, with a preference for anhydrous pyrophosphates.

Polyphosphates having the formula MₓH_{y}PₙO₃ₙ₊₁ where n is 3, 4, 5, . . . , may be used as inorganic phosphate compounds in the present invention. The skilled artisan will nevertheless prefer to use inorganic pyrophosphates or, if using polyphosphates, to combine them with inorganic pyrophosphates.

In one embodiment, the inorganic phosphate compound(s) is(are) added in step a) in the form of a dry powder.

Advantageously, the inorganic phosphate compound (or the mix of inorganic phosphate compounds) is added in step a) at from about 0.1 to 1% (w/w), preferably at from about 0.3 to 0.8% (w/w), more preferably at from about 0.3 to 0.5% (w/w) of the final foodstuff.

According to a second aspect of the present invention, it is herein provided an heat-treated, palatable wet pet foodstuff obtainable by the method as described above.

A third aspect of the present invention relates to an heated, palatable composition useful in wet pet foodstuff, comprising 1) at least one thermal reaction-generated flavour and 2) at least one inorganic phosphate compound, wherein said inorganic phosphate compound enhances the taste of said at least one flavour upon heating.

In other words, according to the present invention, the heated palatable composition useful in wet pet foodstuff thus comprises 1) either (i) at least one flavour that has been generated by thermal reaction from appropriate precursors (i.e., reducing sugars and aminoacids) during the heat treatment undergone by the composition, or (ii) at least one preexisting thermal reaction-generated flavour, or (iii) both (i) and (ii), and 2) at least one inorganic phosphate compound, wherein the taste of said at least one flavour has been enhanced by said inorganic phosphate compound upon heating.

The heated composition of the present invention shows enhanced palatability due to the synergistic action, which is rendered possible upon heating, of the taste-enhancing phosphate compound(s) with the at least one flavour generated by thermal reaction. The heated composition of the present invention is thus a synergistic composition.

In a fourth aspect, the present invention is directed to a palatable composition useful in wet pet foodstuff, comprising 1) at least one thermal reaction-generated flavour and 2) at least one taste-enhancing inorganic phosphate compound, obtainable upon heating at least one reducing sugar and at least one aminoacid, in the presence of said at least one inorganic phosphate compound.

In another embodiment, said palatable composition useful in wet pet foodstuff and comprising 1) at least one thermal reaction-generated flavour and 2) at least one taste-enhancing inorganic phosphate compound, is obtainable upon heating at least one thermal reaction-generated flavour in the presence of at least one inorganic phosphate compound, and optionally in the presence of at least one reducing sugar and/or at least one aminoacid.

Upon heating, these compositions become heated compositions as defined above. Said at least one reducing sugar and said at least one aminoacid are heated, in the presence of said at least one phosphate compound, so that thermal reaction(s) occur(s) as appropriate for flavour generation. The appropriate “heating” conditions for flavour generation are as described above.

According to a fifth aspect, the present invention concerns a palatable composition useful in wet pet foodstuff, comprising 1) at least one thermal reaction-generated flavour and/or precursors thereof, and 2) at least one taste-enhancing inorganic phosphate compound, as a means for preparing a heat-treated, palatable wet pet foodstuff by the method as disclosed above.

Alternatively, according to the present invention, a palatable composition useful in wet pet foodstuff comprises 1) at least one thermal reaction-generated flavour and/or precursors thereof, and 2) at least one taste-enhancing inorganic phosphate compound, as a means for preparing a heat-treated, palatable wet pet foodstuff as defined above.

In a sixth aspect, the present invention relates to an heatable, palatable composition useful in wet pet foodstuff, comprising 1) precursors of at least one thermal reaction-generated flavour and 2) at least one taste-enhancing inorganic phosphate compound, wherein the palatability of said composition is enhanced upon heating.

In other words, this heatable, palatable composition comprises 1) aminoacid and reducing sugar precursors of at least one thermal reaction-generated flavour and 2) at least one taste-enhancing inorganic phosphate compound, and the palatability of said composition is enhanced upon heating.

In another embodiment, the heatable, palatable composition useful in wet pet foodstuff according to the present invention comprises 1) at least one thermal reaction-generated flavour and 2) at least one taste-enhancing inorganic phosphate compound, and the palatability of said composition is enhanced upon heating.

In yet another embodiment, the heatable, palatable composition useful in wet pet foodstuff comprises 1) at least one thermal reaction-generated flavour and precursors thereof, and 2) at least one taste-enhancing inorganic phosphate compound, and the palatability of said composition is enhanced upon heating.

In other words, the sixth aspect according to the present invention relates to an heatable, palatable composition useful in wet pet foodstuff, comprising 1) at least one thermal reaction-generated flavour and/or precursors thereof, and 2) at least one taste-enhancing inorganic phosphate compound, wherein the palatability of said composition is enhanced upon heating.

The expression “upon heating” means that heating is performed so that thermal reaction(s) take(s) place as appropriate for flavour generation.

According to a seventh aspect of the invention, it is provided a method for enhancing the palatability of a wet pet foodstuff.

In a first embodiment, said method comprises:

a) adding 1) at least one taste-enhancing inorganic phosphate compound and/or 2) precursors of at least one thermal reaction-generated flavour, to a wet pet foodstuff preparation;
b) heating the resulting preparation at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining said wet pet foodstuff having enhanced palatability.

In a second embodiment, said method comprises:

a) adding 1) at least one taste-enhancing inorganic phosphate compound and/or 2) at least one thermal reaction-generated flavour, to a wet pet foodstuff preparation;
b) heating the resulting preparation at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining said wet pet foodstuff having enhanced palatability.

In a third embodiment, said method comprises:

a) adding 1) at least one taste-enhancing inorganic phosphate compound and/or 2) at least one thermal reaction-generated flavour and precursors thereof, to a wet pet foodstuff preparation;
b) heating the resulting preparation at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining said wet pet foodstuff having enhanced palatability.

In other words, the seventh aspect of the present invention relates to a method for enhancing the palatability of a wet pet foodstuff, comprising:

a) adding 1) at least one taste-enhancing inorganic phosphate compound and/or 2) at least one thermal reaction-generated flavour and/or precursors thereof, to a wet pet foodstuff preparation;
b) heating the resulting preparation at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining said wet pet foodstuff having enhanced palatability.

With respect to this aspect of the invention, said foodstuff may be yet existing and it is the starting material the palatability of which is to be enhanced. In other cases, the palatability-enhanced foodstuff is prepared ab initio.

An eighth aspect of the present invention is related to a method for enhancing the palatability of at least one flavour generated by thermal reaction.

According to a first embodiment, said method comprises:

a) adding at least one taste-enhancing inorganic phosphate compound to precursors of said at least one flavour;
b) heating the resulting composition at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining an heated composition comprising said at least one flavour having enhanced palatability.

According to a second embodiment, said method comprises:

a) adding at least one taste-enhancing inorganic phosphate compound to said at least one flavour;
b) heating the resulting composition at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining an heated composition comprising said at least one flavour having enhanced palatability.

According to a third embodiment, said method comprises:

a) adding at least one taste-enhancing inorganic phosphate compound to said at least one flavour and precursors thereof;
b) heating the resulting composition at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining an heated composition comprising said at least one flavour having enhanced palatability.

In other words, the eighth aspect of the present invention is related to a method for enhancing the palatability of at least one flavour generated by thermal reaction, said method comprising:

a) adding at least one taste-enhancing inorganic phosphate compound to said at least one flavour and/or precursors thereof;
b) heating the resulting composition at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining an heated composition comprising said at least one flavour having enhanced palatability.

As mentioned above, the precursors comprise at least one reducing sugar and at least one aminoacid.

All the methods of the present invention are of course useful for preparing wet pet foodstuffs.

According to a ninth aspect, the present invention concerns a method for obtaining a heated composition useful in wet pet foodstuff and having enhanced palatability.

In a first embodiment, said method comprises:

a) adding at least one taste-enhancing inorganic phosphate compound to precursors of at least one thermal-generated flavour;
b) heating the resulting composition at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining said heated composition having enhanced palatability.

In a second embodiment, said method comprises:

a) adding at least one taste-enhancing inorganic phosphate compound to at least one thermal-generated flavour;
b) heating the resulting composition at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining said heated composition having enhanced palatability.

In a third embodiment, said method comprises:

a) adding at least one taste-enhancing inorganic phosphate compound to at least one thermal-generated flavour and precursors thereof;
b) heating the resulting composition at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining said heated composition having enhanced palatability.

In other words, the ninth aspect of the present invention concerns a method for obtaining a heated composition useful in wet pet foodstuff and having enhanced palatability, wherein said method comprises:

a) adding at least one taste-enhancing inorganic phosphate compound to at least one thermal-generated flavour and/or precursors thereof;
b) heating the resulting composition at a temperature in the range of about 100 to 150° C., preferably about 121 to 135° C., more preferably about 121 to 128° C., for about 8 to 100 minutes, preferably about 10 to 80 minutes, more preferably about 20 to 75 minutes; and
c) obtaining said heated composition having enhanced palatability.

A tenth aspect of the present invention is directed to an heated composition useful in wet pet foodstuff and having enhanced palatability, obtainable by the method according to the aforementioned eighth or ninth aspect.

In a eleventh aspect, the present invention concerns the use of at least one inorganic phosphate compound as a taste enhancer upon heating of at least one thermal reaction-generated flavour.

In other words, it is provided by the invention, the use of at least one inorganic phosphate compound as a taste enhancer upon heating of at least one flavour generated by thermal reaction.

A twelfth aspect of the invention is related to the use of at least one inorganic phosphate compound in synergistic combination with at least one thermal reaction-generated flavour, for the preparation of a composition having enhanced palatability upon heating.

All the above uses are advantageous for preparing wet pet foodstuffs.

The present invention is illustrated by the following non-limiting examples. The person skilled in the art will also find therein illustration of further advantages and embodiments of the invention.

### EXAMPLES

### 1. Example 1

### Example of the Addition of Trisodium Pyrophosphate to Sugars and Amino Acids in a Chunk-in-Jelly Product

### 1.1. Chunk-in-Jelly Product Manufacturing

Two chunk-in-jelly products for cats were manufactured as follows.

### Product A—Control

The chunks were manufactured using the following protocol:
Frozen beef blood: 8%
Chicken viscera: 5%
Powdered Hemoglobin: 0.25%
Pork liver: 4%
Frozen poultry mix (turkey & chicken carcass, necks, legs, heads in natural proportions): 44%
Fish by-products (Salmon & Cod cutting waste): 14.5%
Wheat Flour: 20%
Wheat Gluten: 1%
Salt (NaCl): 0.3%
Sodium nitrite: 0.6%
Sodium Tripolyphosphate: 0.5%
Water: 1.85%

The raw materials (Frozen beef blood, Chicken viscera, Pork liver, Frozen poultry mix, Fish by-products) were ground in a vertical cutter (Stephan, Germany) for 5 min at 1500 tr/min. Then water was added. Afterwards all the powdered ingredients (mixed beforehand with a whisk) were poured into the slurry. The slurry was then ground and mixed for another 3 min. The total amount of slurry was 15 kg.

The slurry was transferred to a vacuum filler (Handtmann, Germany) and formed into 10 mm diameter cords on cooking griddles. The griddles were transferred into a steam oven (Capic, France, preheated beforehand) and the cords were steam cooked at 98° C., 100% humidity for 4 min. They were allowed to cool to room temperature and cut into 10 mm chunks. Then the chunks were dosed in 10 g pouches (50 g chunks per pouch).

The jelly was manufactured using the following protocol:

Water (14.467 kg) was heated to 80° C. in a vertical cutter (Stephan, Germany). Then 23 g caramel (SLB 16000, Nigay, France) was poured into the water and mixed manually thanks to a whisk. Then 45 g carrageenan (Ceamgel 1843, Ceamsa, Spain), 105 g mix of galactomannan & xanthan (Matgum CG7, Alliance Gums & Indutries SA, France), 90 g xylose (AMC Chemicals, UK), 90 g dextrose (AVEBE, The Netherlands), 60 g glycine (AMC Chemicals, UK), 60 g monosodium glutamate (Quimdis, France) and 60 g methionine (AMC Chemicals, UK) were mixed together using a whisk. The powders were then poured into the hot jelly. The jelly was then mixed at 3000 tr/min under vacuum (−1 bar) for 3 min.

It was then transferred to a vacuum filler (Handtmann, Germany) and dosed into the pouches (50 g jelly per pouch).

The pouches were then sealed with a vacuum sealer (Bernhardt, France). They were retorted in a Surdry retort (Surdry, Spain) using the following process: heating to 127.3° C. in 12 min, temperature maintained at 127.3° C. for 17 min, cooling to 50° C. in 15 min.

They were then allowed to cool down at 4° C. for 1 hour.

### Product B

The manufacturing protocol was the same as for product A, except that the jelly was made using 14.377 kg water, 23 g caramel (SLB 16000, Nigay, France), 45 g carrageenan (Ceamgel 1843, Ceamsa, Spain), 105 g mix of galactomannan & xanthan (Matgum CG7, Alliance Gums & Indutries SA, France), 90 g xylose (AMC Chemicals, UK), 90 g dextrose (AVEBE, The Netherlands), 60 g glycine (AMC Chemicals, UK), 60 g monosodium glutamate (Quimdis, France), 60 g methionine (AMC Chemicals, UK) and 90 g trisodium pyrophosphate Na₃HP₂O₇ (Budenheim, Germany).

### 1.2. Palatability Assessment

The palatability of the two products was assessed at Panelis (France), using a two-bowl test (two short meals per day for two days) on 40 cats. The two foods were presented at the same time to each cat in an individual loose box. Each food amount was sufficient to meet the cat's nutritional needs and their positions in the loose box were switched at each meal to avoid a choice lead by handedness. The 1^{st} food chosen was noted, as well as the final consumption of each food. The data were summed for each day. The results are shown as relative consumption ratios of A or B. Statistical treatment was carried out (Chi-two test for 1^{st} choice and Student test for consumption ratio). Only animals that had consumed normally were validated. The results presented in Table 1 show that product B (containing trisodium pyrophosphate) is preferred to food A.

TABLE 1

| | | |
|---|---|---|
| | Relative | |
| 1^{st} choice | consumption ratio | Ratio (Student |
| (Chi-two test) | (%) | test) |

Day 1

| | | | |
|---|---|---|---|
| Product A - | | 17 | |
| Control | | | |
| Product B | ** | 83 | *** |

Day 2

| | | | |
|---|---|---|---|
| Product A - | | 20 | |
| Control | | | |
| Product B | *** | 80 | *** |

(**): Highly significant (p < 0.01)
(***): Very highly significant (p < 0.001)

### 2. Example 2

### Example of the Addition of Trisodium Pyrophosphate to Sugars and Amino Acids in a Chunk-in-Jelly Product

### Other Recipe

### 2.1. Chunk-in-Jelly Product Manufacturing

Two chunk-in-jelly products for cats were manufactured as follows.

### Product A—Control

The manufacturing protocol was the same as for product A in example 1, but the jelly was made using 14.467 kg water, 23 g caramel (SLB 16000, Nigay, France), 45 g carrageenan (Ceamgel 1843, Ceamsa, Spain), 105 g mix of galactomannan & xanthan (Matgum CG7, Alliance Gums & Indutries SA, France), 180 g xylose (AMC Chemicals, UK) and 180 g glycine (AMC Chemicals, UK).

### Product B

The manufacturing protocol was the same as for product A, except that the jelly was made using 14.377 kg water, 45 g carrageenan (Ceamgel 1843, Ceamsa, Spain), 105 g mix of galactomannan & xanthan (Matgum CG7, Alliance Gums & Indutries SA, France), 180 g xylose (AMC Chemicals, UK), 180 g glycine (AMC Chemicals, UK) and 90 g trisodium pyrophosphate Na₃HP₂O₇ (Budenheim, Germany).

### 2.2. Palatability Assessment

The palatability of the two products was assessed using the same protocol as for example 1. The results presented in Table 2 show that product B (containing trisodium pyrophosphate) is preferred to food A.

TABLE 2

| | | |
|---|---|---|
| | Relative | |
| 1^{st} choice | Consumption ratio | Ratio (Student |
| (Chi-two test) | (%) | test) |

Day 1

| | | | |
|---|---|---|---|
| Product A - | | 28 | |
| Control | | | |
| Product B | ** | 72 | *** |

Day 2

| | | | |
|---|---|---|---|
| Product A - | | 24 | |
| Control | | | |
| Product B | *** | 76 | *** |

(**): Highly significant (p < 0.01)
(***): Very highly significant (p < 0.001)

### 3. Example 3

### Example of the Addition of Sugars and Amino Acids to a Food Product Containing Trisodium Pyrophosphate in a Chunk-in-Jelly Product

### 3.1. Chunk-in-Jelly Product Manufacturing

Two chunk-in-jelly products for cats were manufactured as follows.

### Product A—Control

The manufacturing protocol was the same as for product B in example 1, except that the jelly was made using 14.737 kg water, 23 g caramel (SLB 16000, Nigay, France), 45 g carrageenan (Ceamgel 1843, Ceamsa, Spain), 105 g mix of galactomannan & xanthan (Matgum CG7, Alliance Gums & Indutries SA, France) and 90 g trisodium pyrophosphate Na₃HP₂O₇ (Budenheim, Germany).

### Product B

The manufacturing protocol was the same as for product A, except that that the jelly was made using 14.377 kg water, 23 g caramel (SLB 16000, Nigay, France), 45 g carrageenan (Ceamgel 1843, Ceamsa, Spain), 105 g mix of galactomannan & xanthan (Matgum CG7, Alliance Gums & Indutries SA, France), 180 g xylose (AMC Chemicals, UK), 180 g glycine (AMC Chemicals, UK) and 90 g trisodium pyrophosphate Na₃HP₂O₇ (Budenheim, Germany).

### 3.2. Palatability Assessment

The palatability of the two products was assessed using the same protocol as for example 1. The results presented in Table 3 show that product B (containing trisodium pyrophosphate and sugars and amino acids) is preferred to food A.

TABLE 3

| | | |
|---|---|---|
| | Relative | |
| 1^{st} choice | Consumption ratio | Ratio (Student |
| (Chi-two test) | (%) | test) |

Day 1

| | | | |
|---|---|---|---|
| Product A - | | 10 | |
| Control | | | |
| Product B | *** | 90 | *** |

Day 2

| | | | |
|---|---|---|---|
| Product A - | | 7 | |
| Control | | | |
| Product B | *** | 83 | *** |

(***): Very highly significant (p < 0.001)

### 4. Example 4

### Example of the Addition of Tetrasodium Pyrophosphate to Sugars and Amino Acids in a Chunk-in-Jelly Product

### 4.1. Chunk-in-Jelly Product Manufacturing

Two chunk-in-jelly products for cats were manufactured as follows.

### Product A—Control

The manufacturing protocol was the same as for product A in example 2.

### Product B

The manufacturing protocol was the same as for product A, except that the jelly was made using 14.377 kg water, 45 g carrageenan (Ceamgel 1843, Ceamsa, Spain), 105 g mix of galactomannan & xanthan (Matgum CG7, Alliance Gums & Indutries SA, France), 180 g xylose (AMC Chemicals, UK), 180 g glycine (AMC Chemicals, UK) and 90 g tetrasodium pyrophosphate Na₄P₂O₇ (Budenheim, Germany).

### 4.2. Palatability Assessment

The palatability of the two products was assessed using the same protocol as for example 2. The results presented in Table 4 show that product B (containing tetrasodium pyrophosphate) is preferred to food A.

TABLE 4

| | | |
|---|---|---|
| | Relative | |
| 1^{st} choice | Consumption ratio | Ratio (Student |
| (Chi-two test) | (%) | test) |

Day 1

| | | | |
|---|---|---|---|
| Product A - | | 34 | |
| Control | | | |
| Product B | * | 66 | ** |

Day 2

| | | | |
|---|---|---|---|
| Product A - | | 32 | |
| Control | | | |
| Product B | ** | 68 | *** |

(*): Significant (p < 0.05)
(**): Highly significant (p < 0.01)
(***): Very highly significant (p < 0.001)

### 5. Example 5

### Example of the Effect of Heat on a Drinkable Solution containing trisodium pyrophosphate, sugars and amino acids

### 5.1. Drinkable Solution Manufacturing

A drinkable solution was manufactured as follows: 19.500 kg water were weighed in a bucket. Then 60 g carrageenan (Ceamgel 1843, Ceamsa, Spain), 140 g mix of galactomannan & xanthan (Matgum CG7, Alliance Gums & Indutries SA, France), 120 g xylose (AMC Chemicals, UK), 120 g glycine (AMC Chemicals, UK) and 60 g trisodium pyrophosphate Na₃HP₂O₇ (Budenheim, Germany) were poured into the water. The powders were solubilized using a blender (Dynamic, France) for 5 min. The solution was split in 2 equal parts: Solution A & solution B.

### Solution A—Control

Solution A was poured into twenty 500 mL Schott bottles (Schott, Germany). 3 g of 50% potassium sorbate solution (Nutrinova, Germany) was added to each bottle and the solution was stirred for 1 min.

### Solution B

Solution B was manufactured following the same protocol as for Solution A, except it was retorted for 10 min at 121.1° C. in a 270 L vertical retort (Lequeux, France) before the addition of potassium sorbate.

### 5.2. Palatability Assessment

Palatability assessment was carried out the next day.

The palatability of the two products was assessed in two separate bowls using the same protocol as for example 1, except that the foods were lapped by the cats as a gravy. The results presented in Table 5 show that solution B (containing sugars and amino acids and trisodium pyrophosphate after heating) is preferred to solution A (containing sugars and amino acids and trisodium pyrophosphate without heating).

TABLE 5

| | | |
|---|---|---|
| | Relative | |
| 1^{st} choice | Consumption ratio | Ratio (Student |
| (Chi-two test) | (%) | test) |

Day 1

| | | | |
|---|---|---|---|
| Solution A - | | 8 | |
| Control | | | |
| Solution B | *** | 92 | *** |

Day 2

| | | | |
|---|---|---|---|
| Solution A - | | 5 | |
| Control | | | |
| Solution B | *** | 95 | *** |

(***): Very highly significant (p > 0.001)

### 6. Example 6

### Example of the Addition of Trisodium Pyrophosphate to Sugars and Amino Acids in a Loaf

### 6.1. Loaf Manufacturing

Two loaf products for cats were manufactured as follows.

### Product A—Control

Frozen pork lungs: 4.885 kg
Frozen chicken lung & liver: 6.500 kg
Frozen pork livers: 0.825 kg
Frozen chicken carcass: 4.885 kg
Petigel 18F (CHT, Germany): 0.220 kg
Stabigel V500 (CHT, Germany): 0.025 kg
Mix of vitamins & minerals: 0.103 kg
Sugars and amino acids (30 g xylose (AMC Chemicals, UK), 30 g dextrose (AVEBE, The Netherlands), 20 g glycine (AMC Chemicals, UK), 20 g monosodium glutamate (Quimdis, France), 20 g methionine (AMC Chemicals, UK)
Water: 7.308 kg

The raw materials (pork lungs, chicken lung & liver, pork livers, chicken carcass) were allowed to thaw overnight at room temperature. Then they were were ground in a vertical cutter (Stephan, Germany) for 5 min at 1500 tr/min.

Water was poured into a bucket. The powders (Petigel 18F, Stabigel V500, Mix of vitamins & minerals, Sugars and amino acids) were solubilized in the water thanks to a blender (Dynamic, France). The solution was added to the ground meats and mixed for another 5 min under vacuum (−1 bar) in the cutter.

The slurry was transferred to a vacuum filler (Handtmann, Germany) and dosed into 400 g iron cans. The cans were seamed and retorted in a Microflow retort (Barriquand, France), using the following process: heating to 127° C. in 13 min, temperature maintained at 127° C. for 55 min, cooling to 20° C. in 15 min.

### Product B

The manufacturing protocol was the same as for product A, except that 75 g trisodium pyrophosphate Na₃HP₂O₇ (Budenheim, Germany) was added to the water at the same time as the other powders.

### 6.2. Palatability Assessment

The palatability of the two products was assessed using the same protocol as for example 1. The results shown in Table 6 show that product B (containing trisodium pyrophosphate) is preferred to food A.

TABLE 6

| | | |
|---|---|---|
| | Relative | |
| 1^{st} choice | Consumption ratio | Ratio (Student |
| (Chi-two test) | (%) | test) |

Day 1

| | | | |
|---|---|---|---|
| Product A - | | 31 | |
| Control | | | |
| Product B | * | 69 | *** |

Day 2

| | | | |
|---|---|---|---|
| Product A - | | 27 | |
| Control | | | |
| Product B | ** | 73 | *** |

(*): Significant (p < 0.05)
(**): Highly significant (p < 0.01)
(***): Very highly significant (p < 0.001)

### 7. Example 7

### Example of the Addition of Trisodium Pyrophosphate to a Preexisting Thermal Reaction-Generated Flavour in a Loaf

### 7.1. Loaf Manufacturing

Two loaf products for cat were manufactured as follows.

### Product A—Control

The manufacturing protocol was the same as for product A in example 6, except that the sugars and amino acids were replaced by 120 g Super Premium poultry-based palatability enhancer C′Sens W9P 9408 (SPF, France).

### Product B

The manufacturing protocol was the same as for product A, except that 75 g trisodium pyrophosphate Na₃HP₂O₇ (Budenheim, Germany) was added to the water at the same time as the other powders.

### 7.2. Palatability Assessment

The palatability of the two products was assessed using the same protocol as for example 1. The results shown in Table 7 show that product B (containing trisodium pyrophosphate) is preferred to food A.

TABLE 7

| | | |
|---|---|---|
| | Relative | |
| 1^{st} choice | Consumption ratio | Ratio (Student |
| (Chi-two test) | (%) | test) |

Day 1

| | | | |
|---|---|---|---|
| Product A - | | 40 | |
| Control | | | |
| Product B | * | 60 | * |

Day 2

| | | | |
|---|---|---|---|
| Product A - | | 34 | |
| Control | | | |
| Product B | * | 66 | ** |

(*): Significant (p < 0.05)
(**): Highly significant (p < 0.01)

1-26. (canceled)

27. A method for preparing a heat-treated, palatable wet pet foodstuff, comprising:
a) adding 1) at least one inorganic phosphate compound selected from the group consisting of polyphosphates, inorganic pyrophosphates, and combinations thereof, and 2) at least one thermal reaction-generated flavour, to a wet pet foodstuff preparation;
b) heating the resulting preparation at a temperature in the range of about 100 to 150° C. for about 8 to 100 minutes; and
c) obtaining said palatable wet pet foodstuff, wherein palatability of said thermal reaction-generated flavour is enhanced by said inorganic phosphate compound.

28. A method for preparing a heat-treated, palatable wet pet foodstuff, comprising:
a) adding 1) at least one inorganic phosphate compound selected from the group consisting of polyphosphates, inorganic pyrophosphates, and combinations thereof, and 2) precursors of a thermal reaction-generated flavour, said precursors comprising at least one reducing sugar and at least one aminoacid, to a wet pet foodstuff preparation;
b) heating the resulting preparation at a temperature in the range of about 100 to 150° C. for about 8 to 100 minutes; and
c) obtaining said palatable wet pet foodstuff, wherein palatability of said thermal reaction-generated flavour is enhanced by said inorganic phosphate compound.

29. The method according to claim 27, wherein said foodstuff is no less than about 60% moisture.

30. The method according to claim 27, wherein said at least one inorganic phosphate compound is an inorganic pyrophosphate.

31. The method according to claim 27, wherein said at least one inorganic phosphate compound is added in step a) in the form of a dry powder.

32. The method according to claim 27, wherein said at least one inorganic phosphate compound is added in step a) at from about 0.1 to 1% (w/w) of the final foodstuff.

33. The method according to claim 27, wherein said thermal reaction-generated flavour is added in step a) in the form of a dry powder.

34. The method according to claim 27, wherein said thermal reaction-generated flavour is added in step a) at from about 0.1 to 3% (w/w) of the final foodstuff.

35. The method according to claim 27, wherein said foodstuff is edible or drinkable.

36. The method according to claim 27, wherein said pet is a cat or a dog.

37. A heat-treated, palatable wet pet foodstuff obtainable by the method according to claim 27.

38. A heated, palatable composition for wet pet foodstuff, comprising 1) at least one thermal reaction-generated flavour and 2) at least one inorganic phosphate compound selected from the group consisting of polyphosphates, inorganic pyrophosphates, and combinations thereof, wherein said inorganic phosphate compound enhances the taste of said thermal reaction-generated flavour upon heating.

39. A palatable composition for wet pet foodstuff comprising 1) at least one thermal reaction-generated flavour and 2) at least one taste-enhancing inorganic phosphate compound selected from the group consisting of polyphosphates, inorganic pyrophosphates, and combinations thereof, obtainable upon heating at least one reducing sugar and at least one aminoacid, in the presence of said inorganic phosphate compound.

40. A palatable composition for wet pet foodstuff comprising 1) at least one thermal reaction-generated flavour and 2) at least one taste-enhancing inorganic phosphate compound selected from the group consisting of polyphosphates, inorganic pyrophosphates, and combinations thereof obtainable upon heating at least one thermal reaction-generated flavour in the presence of said inorganic phosphate compound.

41. A method for enhancing the palatability of a wet pet foodstuff, comprising:
a) adding 1) at least one taste-enhancing inorganic phosphate compound selected from the group consisting of polyphosphates, inorganic pyrophosphates, and combinations thereof, and/or 2) at least one thermal reaction-generated flavour, to a wet pet foodstuff preparation;
b) heating the resulting preparation at a temperature in the range of about 100 to 150° C. for about 8 to 100 minutes; and
c) obtaining said wet pet foodstuff having enhanced palatability.

42. A method for enhancing the palatability of a wet pet foodstuff, comprising:
a) adding 1) at least one taste-enhancing inorganic phosphate compound selected from the group consisting of polyphosphates, inorganic pyrophosphates, and combinations thereof and/or 2) precursors of a thermal reaction-generated flavour, said precursors comprising at least one reducing sugar and at least one aminoacid, to a wet pet foodstuff preparation;
b) heating the resulting preparation at a temperature in the range of about 100 to 150° C. for about 8 to 100 minutes; and
c) obtaining said wet pet foodstuff having enhanced palatability.

43. A method for enhancing the palatability of at least one flavour generated by thermal reaction and useful in wet pet foodstuff, comprising:
a) adding at least one taste-enhancing inorganic phosphate compound selected from the group consisting of polyphosphates, inorganic pyrophosphates, and combinations thereof, to said flavour;
b) heating the resulting composition at a temperature in the range of about 100 to 150° C. for about 8 to 100 minutes; and
c) obtaining an heated composition comprising said flavour having enhanced palatability.

44. A method for enhancing the palatability of at least one flavour generated by thermal reaction and useful in wet pet foodstuff, comprising:
a) adding at least one taste-enhancing inorganic phosphate compound selected from the group consisting of polyphosphates, inorganic pyrophosphates, and combinations thereof, to precursors of a thermal reaction-generated flavour, said precursors comprising at least one reducing sugar and at least one aminoacid;
b) heating the resulting composition at a temperature in the range of about 100 to 150° C. for about 8 to 100 minutes; and
c) obtaining an heated composition comprising said flavour having enhanced palatability.

45. A method for obtaining a heated composition for wet pet foodstuff and having enhanced palatability, comprising:
a) adding at least one taste-enhancing inorganic phosphate compound selected from the group consisting of polyphosphates, inorganic pyrophosphates, and combinations thereof, to at least one thermal-generated flavour;
b) heating the resulting composition at a temperature in the range of about 100 to 150° C. for about 8 to 100 minutes; and
c) obtaining said heated composition having enhanced palatability.

46. A method for obtaining a heated composition for wet pet foodstuff and having enhanced palatability, comprising:
a) adding at least one taste-enhancing inorganic phosphate compound selected from the group consisting of polyphosphates, inorganic pyrophosphates, and combinations thereof, to precursors of a thermal reaction-generated flavour, said precursors comprising at least one reducing sugar and at least one aminoacid;
b) heating the resulting composition at a temperature in the range of about 100 to 150° C. for about 8 to 100 minutes; and
c) obtaining said heated composition having enhanced palatability.

47. The method according to claim 28, wherein said precursors are added in step a) in the form of a dry power.

48. The method according to claim 28, wherein said precursors are added in step a) at from about 0.1 to 3% (w/w) of the final foodstuff.

49. The method according to claim 27, wherein said pet is a cat.
